(19) United States
(12) Patent Application Publication
(10) Pub. No.: US 2022/0108162 A1
(43) Pub. Date: Apr. 7, 2022

(54) DECIMATING HIDDEN LAYERS FOR TRAINING TRANSFORMER MODELS

(71) Applicant: Microsoft Technology Licensing, LLC, Redmond, WA (US)

(72) Inventors: Andy WAGNER, Cupertino, CA (US); Tiyasa MITRA, San Jose, CA (US); Marc TREMBLAY, Bellevue, WA (US)

(21) Appl. No.: 17/061,499

(22) Filed: Oct. 1, 2020

(51) Int. Cl. G06N 3/08; G06N 3/04

(52) U.S. Cl. CPC G06N 3/08; G06N 3/04

(57) ABSTRACT

Embodiments of the present disclosure include systems and methods for decimating hidden layers for training transformer models. In some embodiments, input data for training a transform model is received receive at a transformer layer included in the transformer model. The transformer layer comprises a hidden layer. The hidden layer comprises a set of neurons configured to process training data. A subset of the set of neurons of the hidden layer is selected. Only the subset of the set of neurons of the hidden layer are used to train the transformer model with the input data.

### BACKGROUND

The present disclosure relates to a computing system. More particularly, the present disclosure relates to techniques for training a neural network.

Natural-language understanding (NLU) is a subfield of natural-language processing (NLP) in artificial intelligence that addresses comprehension by computers of the structure and meaning of human language. NLU enables voice technology, search engines, and machine translation to deduce what a user means, regardless of the way it is expressed

A neural network is a machine learning model that underpins NLU applications. A neural network is trained for a particular purpose by running datasets through it, comparing results from the neural network to known results, and updating the network based on the differences.

### BRIEF DESCRIPTION OF THE DRAWINGS

Various embodiments of the present disclosure are illustrated by way of example and not limitation in the figures of the accompanying drawings.

FIG. 1 illustrates a system for training a transformer model according to some embodiments.

FIG. 2 illustrates an example of transformer layers according to some embodiments.

FIGS. 3A-3D illustrate an example of decimating hidden layers for training a transformer model according to some embodiments.

FIG. 4 illustrates a process for decimating hidden layers for training a transformer model according to some embodiments.

FIG. 5 depicts a simplified block diagram of an example computer system according to some embodiments.

FIG. 6 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for decimating hidden layers for training transformer models. In some embodiments, a transformer model includes several transformer layers. Each transformer layer includes an input layer, a set of hidden layers, and an output layer. Each of these layers can include a set of neurons. When training the transformer model, training data is processed through the transformer layers of the transformer model. At the first transformer layer that receives a set of training data, a subset of the neurons of the hidden layer that receives output from the input layer is selected. Then, only that subset of the neurons are used to process the set of training data. For each subsequent set of training data, a different subset of the neurons of this hidden layer may be selected and used to process the set of training data.

The techniques described in the present application provide a number of benefits and advantages over conventional methods of training transformer models. For instance, by decimating neurons of a hidden layer in using the techniques described herein, the complexity of neural network is reduced when training a transformer model. In addition, using these techniques reduces the amount of memory used to train the transformer model.

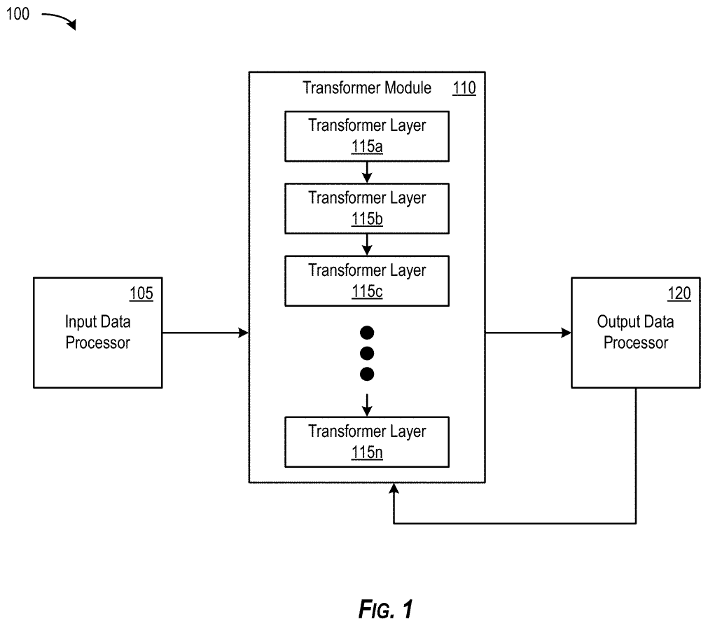

FIG. 1 illustrates a system 100 for training a transformer model according to some embodiments. As shown, system 100 includes input data processor 105, transformer module 110, and output data processor 120. Input data processor 105 is configured to process input data used for training transformer module 110. For example, input data processor 105 may receive a set of input data that includes a sequence of tokens (e.g., a set of words) and a set of position values for the sequence of tokens. A position value may represent the relative position of a particular token in a sequence of tokens. In some cases, a set of input data can also include a set of sentence values. In some embodiments, a sentence value represents a sentence to which a token in the sequence of tokens belongs.

Based on the input data, input data processor 105 can generate a set of training data that includes the sequence of tokens and the set of position values. Once the set of training data is generated, input data processor 105 can select a defined number of tokens in the sequence of tokens or a defined portion of the modified sequence of tokens (e.g., a percentage of the total number tokens in the sequence). In some embodiments, input data processor 105 selects tokens in the sequence randomly. Input data processor 105 then replaces the selected tokens with a defined token value. The selection and replacement of tokens may also referred to as token masking.

After masking tokens in the input data, input data processor 105 may determine token embeddings for each unmasked token in the sequence of tokens using an embedding space generated from a corpus of tokens (e.g., a vocabulary of words). In some embodiments, a token embedding space maps tokens in the corpus, which has many dimension, to numeric representations (e.g., vectors) having a lower number of dimensions. Then, input data processor 105 can determine position embeddings for each unmasked position value in the set of position values using an embedding space generated from a corpus of position values. The range of values in the corpus of position values can be a maximum sequence length (e.g., a maximum number of tokens in a sequence) that transformer module 110 is configured to process. For example, if transformer module 110 is configured to process sequence lengths of 1024, the range of values in the corpus of position values can be 0 to 1023. In some embodiments, a position value embedding space maps position values in the corpus, which has many dimension, to numeric representations (e.g., vectors) having a lower number of dimensions. For groups of same tokens where position values have been combined, input data processor 105 aggregates the position embeddings for these position values together to form an aggregate position embedding. In cases where the input data includes sentence values, input data processor 105 may determine sentence embeddings for each sentence value in the set of sentence values using an embedding space generated from a corpus of sentence values. In some embodiments, a sentence value embedding space maps sentence values in the corpus, which has many dimension, to numeric representations (e.g., vectors) having a lower number of dimensions. Upon determining embeddings for tokens and position values, and/or sentence values, input data processor 105 calculates an aggregate embedding for each token in the sequence of tokens by adding the token embedding, the corresponding position value embedding, and/or the corresponding sentence value embedding together. Finally, input data processor 105 sends the aggregate embeddings to transformer module 110 for training.

Transformer module 110 is responsible for predicting masked tokens given training data that includes unmasked tokens and masked tokens. In some embodiments, transformer module 110 is implemented by a transformer neural network (also referred to as a transformer or a transformer model). In some such embodiments, a transformer neural network has a sequence-to-sequence architecture. That is, the transformer neural network can transforms a given sequence of elements, such as the sequence of words in a sentence, into another sequence. In some embodiments, the transformer neural network includes weights used for predicting masked tokens and masked positions. The transformer neural network can adjust these weights based on feedback (e.g., differences between predicted tokens for masked tokens and actual values of masked tokens, etc.) received from output data processor 120 using a back propagation technique.

Transformer module 110 may determine relationships/correlations between tokens in input data. For instance, transformer module 110 can process tokens in relation to all the other tokens in a sequence, instead of one-by-one in order. In other words, transformer module 110 considers the full context of a token by looking at the tokens that come before and after it. Transformer module 110 may be used for machine translation and search (e.g., conversational queries). Other applications of transformer module 110 include: document summarization, document generation, named entity recognition (NER), speech recognition, and biological sequence analysis.

As shown in FIG. 1, transformer module 110 includes transformer layers 115a-n. Transformer layers 115a-n may be transformer model encoders and/or transformer model decoders. A transformer model encoder can include a self-attention block and a feed-forward neural network. When an encoder processes a given word in an input sequence, the self-attention block may enable the encoder to look at other words in input sequence. The feed-forward neural network can then process and forward the output of the self-attention block to the next encoder the pipeline. A set of attention vectors may be generated from the output of the final encoder. The set of attention vectors can be transmitted to each decoder in the transformer module 110.

Similar to an encoder, a decoder may include a self-attention block and a feed feed-forward neural network. In addition, the decoder can include an encoder-decoder attention block. The encoder-decoder attention block enables the decoder to attend to appropriate positions of an input sequence during processing. The decoder may output a matrix of floating point numbers. Transformer module 110 may convert this matrix into a natural language output sequence.

Output data processor 120 is configured to process data output from transformer module 110. For example, output data processor 120 can receive an array of data from transformer module 110 and label data. The array of data may include a numeric representation (e.g., the aggregate embedding described above) for each token in a sequence of tokens used as input to transformer module 110. The label data can include values of masked tokens in the training data. Next, output data processor 120 identifies the numeric representations of masked tokens in the array of data and determines the predicted tokens for the masked tokens. Output data processor 120 then determines the differences between the predicted tokens for masked tokens and the actual values of the masked tokens specified in the label data. Finally, output data processor 120 sends the calculated differences back to transformer module 110 to adjust the weights of transformer module 110.

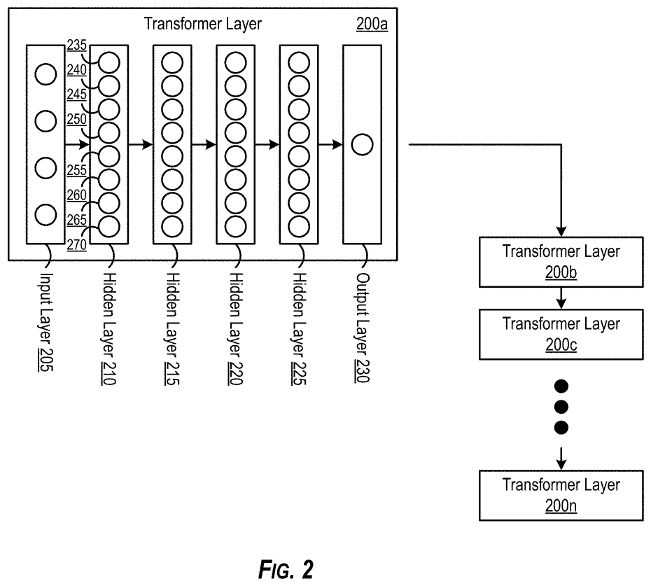

FIG. 2 illustrates an example of transformer layers 200a-n according to some embodiments. In some embodiments, transformer layers 200a-n can be used to implement transformer layers 115a-n of transformer module 110. For the purposes of simplicity and explanation, details of transformer layers 200b-n are not shown in FIG. 2. One of ordinary skill in the art will understand that transformer layers 200b-n can be implemented in the same or similar manner as transformer layer 200a.

As shown in FIG. 1, transformer layer 200a includes input layer 205, hidden layers 210-225, and output layer 230. Each of these layers 205-230 includes one or more neurons (depicted as circles). For example, input layer 205 includes four neurons, hidden layers 210-225 each includes eight neurons 235-270, and output layer 230 includes one neuron. The neurons may include weights that can be adjusted when training of a transformer model (e.g., transformer module 110) implemented by transformer layers 200a-n. Each neuron can be configured to execute an activation function based on its weights and input that the neuron receives.

The neurons of input layer 205 are configured to receive input data (e.g., training data), process it, generate output data, and send the output data to hidden layer 210. the neurons of hidden layer 210 receives the output data from input layer 205, processes it, generates its own output data, and sends this output data to hidden layer 215. The neurons of hidden layers 215-225 each processes the output received from the previous hidden layer in the same or similar manner as hidden layer 210. The neuron of output layer 230 is configured to receive the output of hidden layer 225, process it, generate output data, and send its output data to the next transformer layer (transformer layer 220b). Each of the transformer layers 200b-n processes data in the same or similar manner as transformer layer 200a. In this fashion, training data is propagated through transformer layers 200a-n during training of the transformer model.

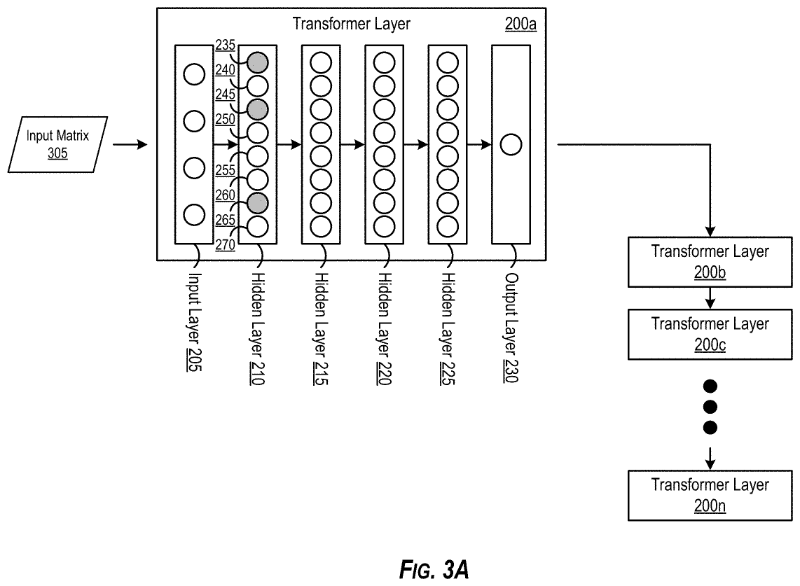

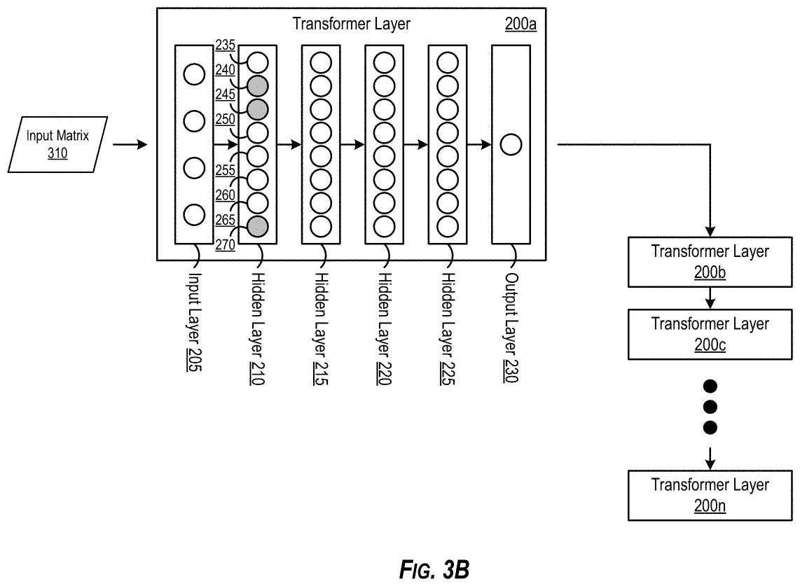

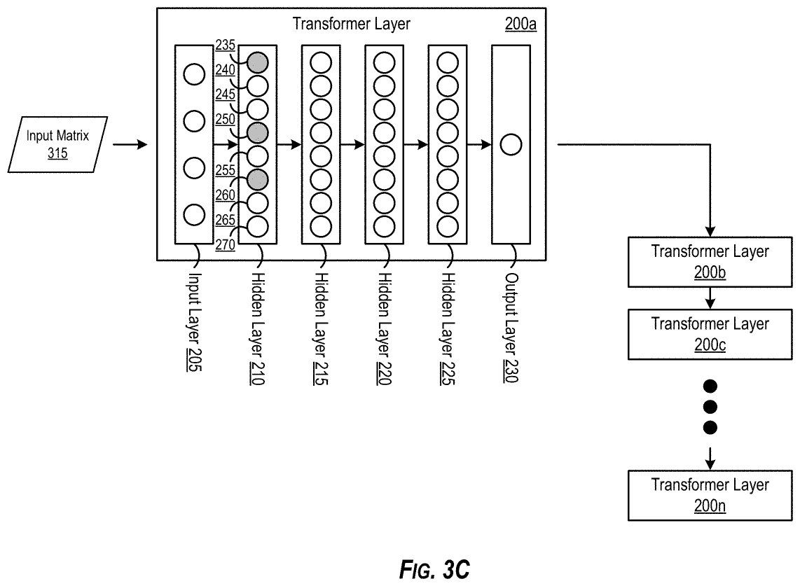

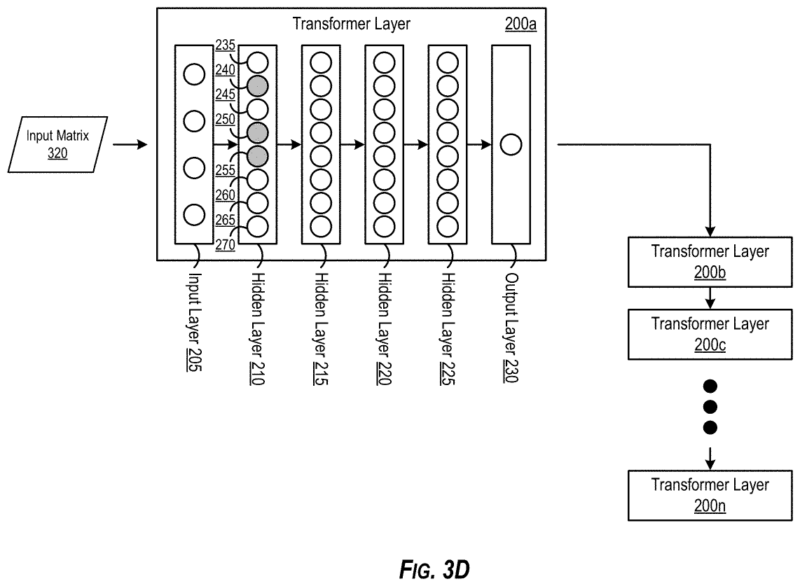

FIGS. 3A-3D illustrate an example of decimating hidden layers for training a transformer model according to some embodiments. Specifically, FIGS. 3A-3D shows an example of selecting different subsets of neurons of a hidden layer for training transformer layers 200a-n using different sets of training data. FIG. 3A illustrates the start of the example is illustrated in FIG. 3A. As shown, transformer layer 200a is receiving input matrix 305 as a set of training data to train transformer layers 200a-n. Input matrix 305 may be a matrix arrays of floating point value where each array of floating point values represents a token in a sequence of tokens (e.g., a word in a sentence). For this example, the neurons of the first hidden layer (hidden layer 210 in this example) of the first transformer layer (transformer layer 200a in this example) are decimated. In particular, transformer layer 200a has randomly selected a subset of neurons (neurons 235, 245, and 265 in this example) of hidden layer 210 that are to be used to train transformer layers 200a-n using input matrix 305.

Each of the non-selected neurons of hidden layer 210 (neurons 240, 250-260, and 270 in this example) can replace (e.g., pad) the output data that it receives from input layer 205 with a defined value (e.g., a zero value). In this manner, information in the output data generated by input layer 205 can be reduced while maintaining the dimensionality of the data. In other words, after portions of the output data generated by input layer 205 are replaced with the defined value, the output data becomes a sparse matrix. In some embodiments, a sparse matrix is a matrix where most of the elements are zero. This characteristic of a sparse matrix may be leveraged to reduce the amount of memory and/or processing power used when processing the sparse matrix (e.g., performing operations on the sparse matrix). After the selected neurons of hidden layer 210 processes the output generated by input layer 205, they generate output data that is transmitted to hidden layer 215. The same or similar operations are successively performed by hidden layers 215-225 as input matrix 305 is propagated through transformer layer 200a. Once transformer layer 200a generates output data and sends it to transformer layer 200b, each of the transformer layers 200b-n processes the data in the same or similar fashion as transformer 200a (but without decimating any the hidden layers) as input matrix 305 is propagated through transformer layers 200b-n.

FIG. 3B illustrates another set of training data being used to train transformer layers 200a-n. As shown in FIG. 3B, transformer layer 200a is receiving input matrix 310 as a set of training data to train transformer layers 200a-n. Input matrix 310 can be a matrix arrays of floating point value where each array of floating point values represents a token in a sequence of tokens (e.g., a word in a sentence). Similar to FIG. 3A, the neurons of hidden layer 210 of transformer layer 200a are decimated. For this example, transformer layer 200a has randomly selected a subset of neurons (neurons 240, 245, and 270 in this example) of hidden layer 210 that are to be used to train transformer layers 200a-n using input matrix 310.

Each of the non-selected neurons of hidden layer 210 (neurons 235 and 250-265 in this example) may replace (e.g., pad) the output data that it receives from input layer 205 with a defined value (e.g., a zero value). After the selected neurons of hidden layer 210 processes the output generated by input layer 205, they generate output data that is transmitted to hidden layer 215. The same or similar operations are successively performed by hidden layers 215-225 as input matrix 310 is propagated through transformer layer 200a. After transformer layer 200a generates output data and sends it to transformer layer 200b, each of the transformer layers 200b-n processes the data in the same or similar fashion as transformer 200a (but without decimating any the hidden layers) as input matrix 310 is propagated through transformer layers 200b-n.

Next, FIG. 3C illustrates another set of training data being used to train transformer layers 200a-n. As depicted in FIG. 3C, transformer layer 200a is receiving input matrix 315 as a set of training data to train transformer layers 200a-n. Input matrix 315 may be a matrix arrays of floating point value where each array of floating point values represents a token in a sequence of tokens (e.g., a word in a sentence). Similar to FIGS. 3A and 3B, the neurons of hidden layer 210 of transformer layer 200a are decimated. In this example, transformer layer 200a has randomly selected a subset of neurons (neurons 235, 250, and 260 in this example) of hidden layer 210 that are to be used to train transformer layers 200a-n using input matrix 315.

Each of the non-selected neurons of hidden layer 210 (neurons 240, 245, 255, 265, and 270 in this example) can replace (e.g., pad) the output data that it receives from input layer 205 with a defined value (e.g., a zero value). After the selected neurons of hidden layer 210 processes the output generated by input layer 205, they generate output data that is transmitted to hidden layer 215. The same or similar operations are successively performed by hidden layers 215-225 as input matrix 315 is propagated through transformer layer 200a. Once transformer layer 200a generates output data and sends it to transformer layer 200b, each of the transformer layers 200b-n processes the data in the same or similar fashion as transformer 200a (but without decimating any the hidden layers) as input matrix 315 is propagated through transformer layers 200b-n.

Finally, FIG. 3D illustrates another set of training data being used to train transformer layers 200a-n. As shown in FIG. 3B, transformer layer 200a is receiving input matrix 320 as a set of training data to train transformer layers 200a-n. Input matrix 320 can be a matrix arrays of floating point value where each array of floating point values represents a token in a sequence of tokens (e.g., a word in a sentence). Similar to FIGS. 3A-3C, the neurons of hidden layer 210 of transformer layer 200a are decimated. For this example, transformer layer 200a has randomly selected a subset of neurons (neurons 240, 250, and 255 in this example) of hidden layer 210 that are to be used to train transformer layers 200a-n using input matrix 320.

Each of the non-selected neurons of hidden layer 210 (neurons 235, 245, and 260-270 in this example) may replace (e.g., pad) the output data that it receives from input layer 205 with a defined value (e.g., a zero value). After the selected neurons of hidden layer 210 processes the output generated by input layer 205, they generate output data that is transmitted to hidden layer 215. The same or similar operations are successively performed by hidden layers 215-225 as input matrix 320 is propagated through transformer layer 200a. After transformer layer 200a generates output data and sends it to transformer layer 200b, each of the transformer layers 200b-n processes the data in the same or similar fashion as transformer 200a (but without decimating any the hidden layers) as input matrix 320 is propagated through transformer layers 200b-n.

FIGS. 3A-3D show an example of decimating hidden layers for training a transformer model by randomly selecting a defined number of neurons in a hidden layer (three neurons in hidden layer 210 for the example). In some embodiments, blocks of contiguous neurons of the hidden layer can be randomly selected as the subset of neurons of the hidden layer. For instance, two blocks of two contiguous neurons (e.g., neighboring neurons) may be randomly selected for each set of training data processed through transformer layers 200a-n. As an example, neurons 0 and 1 (a first block) and neurons 4 and 5 (a second block) of hidden layer 210 can be selected for training transformer layers 200a-n with a first set of training data, neurons 2 and 3 (a first block) and neurons 5 and 6 (a second block) of hidden layer 210 can be selected for training transformer layers 200a-n with a second set of training data, neurons 3 and 4 (a first block) and neurons 5 and 6 (a second block) of hidden layer 210 can be selected for training transformer layers 200a-n with a third set of training data, and so on and so forth. One of ordinary skill in the art will appreciate that any number of different methods for selecting neurons in a hidden layer to process a set of training data may be used.

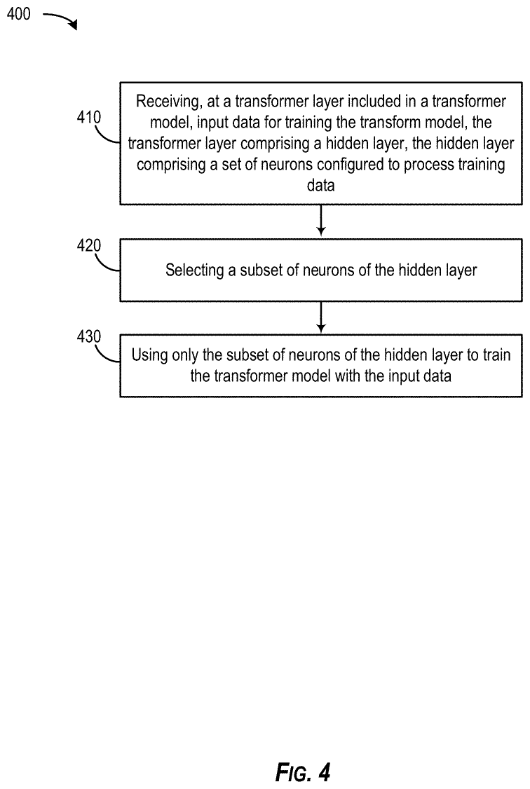

FIG. 4 illustrates a process 400 for decimating hidden layers for training a transformer model according to some embodiments. In some embodiments, transformer module 110 performs process 400. Process 400 begins at operating 410 by receiving, at a transformer layer included in a transformer model, input data for training the transform model. The transformer layer includes a hidden layer. The hidden layer includes a set of neurons configured to process training data. Referring to FIG. 3A as an example, transformer layer 200a receives input matrix 305.

Next, process 400 selects, at 420, a subset of the set of neurons of the hidden layer. Referring to FIG. 3A as an example, transformer layer 200a has selected three neurons of hidden layer 210. Specifically, transformer layer 200a selected neurons 235, 245, and 265. The non-selected neurons of hidden layer 210 (neurons 240, 250-260, and 270 in this example) replaces the output data that it receives from input layer 205 with a defined value (e.g., a zero value).

Finally, process 400 uses, at 430, only the subset of the set of neurons of the hidden layer to train the transformer model with the input data. Referring to FIG. 3A as an example, the selected neurons (neurons 0, 2, and 6) are used to process input matrix 305 through transformer layer 200a. Process 400 is similarly used to decimate hidden layer 210 for training transformer layers 200a-n with input matrices 310-320, as shown in FIGS. 3B-3D.

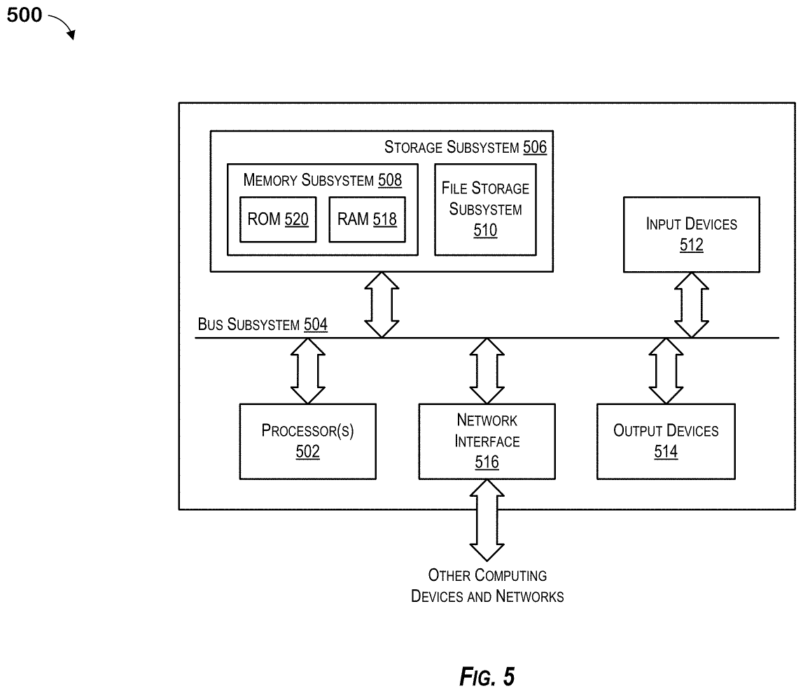

The techniques describe above may be implemented in a wide range of computer systems configured to process neural networks. FIG. 5 depicts a simplified block diagram of an example computer system 500, which can be used to implement the techniques described in the foregoing disclosure. In some embodiments, computer system 500 may be used to implement system 100. As shown in FIG. 5, computer system 500 includes one or more processors 502 that communicate with a number of peripheral devices via a bus subsystem 504. These peripheral devices may include a storage subsystem 506 (e.g., comprising a memory subsystem 508 and a file storage subsystem 510) and a network interface subsystem 516. Some computer systems may further include user interface input devices 512 and/or user interface output devices 514.

Bus subsystem 504 can provide a mechanism for letting the various components and subsystems of computer system 500 communicate with each other as intended. Although bus subsystem 504 is shown schematically as a single bus, alternative embodiments of the bus subsystem can utilize multiple busses.

Network interface subsystem 516 can serve as an interface for communicating data between computer system 500 and other computer systems or networks. Embodiments of network interface subsystem 516 can include, e.g., Ethernet, a Wi-Fi and/or cellular adapter, a modem (telephone, satellite, cable, ISDN, etc.), digital subscriber line (DSL) units, and/or the like.

Storage subsystem 506 includes a memory subsystem 508 and a file/disk storage subsystem 510. Subsystems 508 and 510 as well as other memories described herein are examples of non-transitory computer-readable storage media that can store executable program code and/or data that provide the functionality of embodiments of the present disclosure.

Memory subsystem 508 includes a number of memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 500 is illustrative and many other configurations having more or fewer components than system 500 are possible.

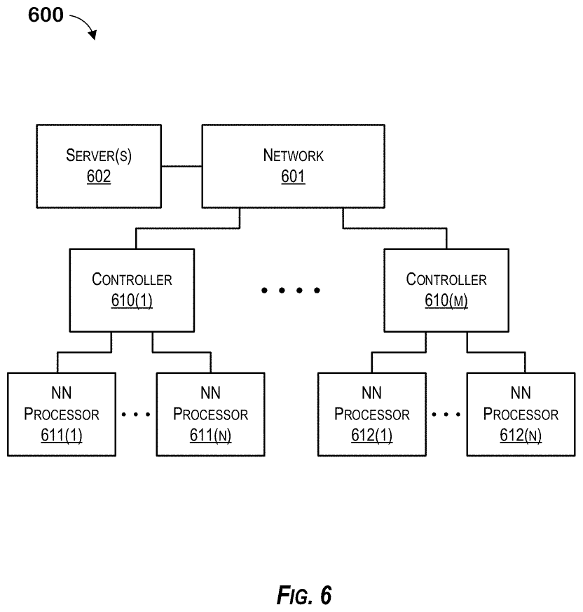

FIG. 6 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 602, which may comprise architectures illustrated in FIG. 5 above, may be coupled to a plurality of controllers 610(1)-610(M) over a communication network 601 (e.g. switches, routers, etc.). Controllers 610(1)-610(M) may also comprise architectures illustrated in FIG. 5 above. Each controller 610(1)-610(M) may be coupled to one or more NN processors, such as processors 611(1)-611(N) and 612(1)-612(N), for example. NN processors 611(1)-611(N) and 612(1)-612(N) may include a variety of configurations of functional processing blocks and memory optimized for neural network processing, such as training or inference. The NN processors are optimized for neural network computations. Server 602 may configure controllers 610 with NN models as well as input data to the models, which may be loaded and executed by NN processors 611(1)-611(N) and 612(1)-612(N) in parallel, for example. Models may include layers and associated weights as described above, for example. NN processors may load the models and apply the inputs to produce output results. NN processors may also implement training algorithms described herein, for example.

### FURTHER EXAMPLE EMBODIMENTS

In various embodiments, the present disclosure includes systems, methods, and apparatuses for decimating hidden layers for training transformer models. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in one embodiment, the present disclosure includes a system comprising a set of processing units and a non-transitory machine-readable medium storing instructions that when executed by at least one processing unit in the set of processing units cause the at least one processing unit to receive, at a transformer layer included in a transformer model, input data for training the transform model, the transformer layer comprising a hidden layer, the hidden layer comprising a set of neurons configured to process training data; select a subset of the set of neurons of the hidden layer; and use only the subset of the set of neurons of the hidden layer to train the transformer model with the input data.

In one embodiment, selecting the subset of the set of neurons of the hidden layer comprises randomly selecting a defined number of neurons in the hidden layer as the subset of the set of neurons of the hidden layer.

In one embodiment, selecting the subset of the set of neurons of the hidden layer comprises randomly selecting blocks of contiguous neurons of the hidden layer as the subset of the set of neurons of the hidden layer.

In one embodiment, the present disclosure further replaces portions of the input data that would be processed by neurons in the hidden layer other than the subset of the set of neurons with a defined value.

In one embodiment, the hidden layer is a first hidden layer. The transformer layer further comprises an input layer and a second hidden layer. The input layer is configured to receive the input data, process the input data, and generate a first output data for the first hidden layer to process. The first hidden layer is configured to receive the first output data, process the first output data, and generate a second output data for the second hidden layer to process.

In one embodiment, the input data is first input data and the subset of the set of neurons of the hidden layer is a first subset. The present disclosure further receives, at the transformer layer included in the transformer model, second input data for training the transform model; selects a second subset of the set of neurons of the hidden layer; and uses only the second subset of the set of neurons of the hidden layer to train the transformer model with the second input data.

In one embodiment, a dimensionality of the input data is maintained when only the subset of the set of neurons of the hidden layer is used to train the transformer model with the input data.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A system comprising:
a set of processing units; and
a non-transitory machine-readable medium storing instructions that when executed by at least one processing unit in the set of processing units cause the at least one processing unit to:
receive, at a transformer layer included in a transformer model, input data for training the transform model, the transformer layer comprising a hidden layer, the hidden layer comprising a set of neurons configured to process training data;
select a subset of the set of neurons of the hidden layer; and
use only the subset of the set of neurons of the hidden layer to train the transformer model with the input data.

2. The system of claim 1, wherein selecting the subset of the set of neurons of the hidden layer comprises randomly selecting a defined number of neurons in the hidden layer as the subset of the set of neurons of the hidden layer.

3. The system of claim 1, wherein selecting the subset of the set of neurons of the hidden layer comprises randomly selecting blocks of contiguous neurons of the hidden layer as the subset of the set of neurons of the hidden layer.

4. The system of claim 1, wherein the instructions further cause the at least one processing unit to replace portions of the input data that would be processed by neurons in the hidden layer other than the subset of the set of neurons with a defined value.

5. The system of claim 1, wherein the hidden layer is a first hidden layer, wherein the transformer layer further comprises an input layer and a second hidden layer, the input layer configured to receive the input data, process the input data, and generate a first output data for the first hidden layer to process, wherein the first hidden layer is configured to receive the first output data, process the first output data, and generate a second output data for the second hidden layer to process.

6. The system of claim 1, wherein the input data is first input data, wherein the subset of the set of neurons of the hidden layer is a first subset, wherein the instructions further cause the at least one processing unit to:
receive, at the transformer layer included in the transformer model, second input data for training the transform model;
select a second subset of the set of neurons of the hidden layer; and
use only the second subset of the set of neurons of the hidden layer to train the transformer model with the second input data.

7. The system of claim 1, wherein a dimensionality of the input data is maintained when only the subset of the set of neurons of the hidden layer is used to train the transformer model with the input data.

8. A method comprising:
receiving, at a transformer layer included in a transformer model, input data for training the transform model, the transformer layer comprising a hidden layer, the hidden layer comprising a set of neurons configured to process training data;
selecting a subset of the set of neurons of the hidden layer; and
using only the subset of the set of neurons of the hidden layer to train the transformer model with the input data.

9. The method of claim 8, wherein selecting the subset of the set of neurons of the hidden layer comprises randomly selecting a defined number of neurons in the hidden layer as the subset of the set of neurons of the hidden layer.

10. The method of claim 8, wherein selecting the subset of the set of neurons of the hidden layer comprises randomly selecting blocks of contiguous neurons of the hidden layer as the subset of the set of neurons of the hidden layer.

11. The method of claim 8 further comprising replacing portions of the input data that would be processed by neurons in the hidden layer other than the subset of the set of neurons with a defined value.

12. The method of claim 8, wherein the hidden layer is a first hidden layer, wherein the transformer layer further comprises an input layer and a second hidden layer, the input layer configured to receive the input data, process the input data, and generate a first output data for the first hidden layer to process, wherein the first hidden layer is configured to receive the first output data, process the first output data, and generate a second output data for the second hidden layer to process.

13. The method of claim 8, wherein the input data is first input data, wherein the subset of the set of neurons of the hidden layer is a first subset, the method further comprising:
receiving, at the transformer layer included in the transformer model, second input data for training the transform model;
selecting a second subset of the set of neurons of the hidden layer; and
using only the second subset of the set of neurons of the hidden layer to train the transformer model with the second input data.

14. The method of claim 8, wherein a dimensionality of the input data is maintained when only the subset of the set of neurons of the hidden layer is used to train the transformer model with the input data.

15. A non-transitory machine-readable medium storing a program executable by at least one processing unit of a computer system, the program comprising sets of instructions for:
receiving, at a transformer layer included in a transformer model, input data for training the transform model, the transformer layer comprising a hidden layer, the hidden layer comprising a set of neurons configured to process training data;
selecting a subset of the set of neurons of the hidden layer; and
using only the subset of the set of neurons of the hidden layer to train the transformer model with the input data.

16. The non-transitory machine-readable medium of claim 15, wherein selecting the subset of the set of neurons of the hidden layer comprises randomly selecting a defined number of neurons in the hidden layer as the subset of the set of neurons of the hidden layer.

17. The non-transitory machine-readable medium of claim 15, wherein selecting the subset of the set of neurons of the hidden layer comprises randomly selecting blocks of contiguous neurons of the hidden layer as the subset of the set of neurons of the hidden layer.

18. The non-transitory machine-readable medium of claim 15, wherein the program further comprises a set of instructions for replacing portions of the input data that would be processed by neurons in the hidden layer other than the subset of the set of neurons with a defined value.

19. The non-transitory machine-readable medium of claim 15, wherein the hidden layer is a first hidden layer, wherein the transformer layer further comprises an input layer and a second hidden layer, the input layer configured to receive the input data, process the input data, and generate a first output data for the first hidden layer to process, wherein the first hidden layer is configured to receive the first output data, process the first output data, and generate a second output data for the second hidden layer to process.

20. The non-transitory machine-readable medium of claim 15, wherein the input data is first input data, wherein the subset of the set of neurons of the hidden layer is a first subset, wherein the program further comprises sets of instructions for:
receiving, at the transformer layer included in the transformer model, second input data for training the transform model;
selecting a second subset of the set of neurons of the hidden layer; and
using only the second subset of the set of neurons of the hidden layer to train the transformer model with the second input data.
